(19) United States
(12) Patent Application Publication
(10) Pub. No.: US 2005/0042503 A1
(43) Pub. Date: Feb. 24, 2005

(54) Lithium-sulfur battery

(76) Inventors: Ju-Yup Kim, Seoul (KR); Young-Gyoon Ryu, Gyeonggi-do (KR)

Correspondence Address: Robert E. Bushnell, Suite 300, 1522 K Street, N.W., Washington, DC, 20005, US

(21) Appl. No.: 10/921,850

(22) Filed: Aug. 20, 2004

(30) Foreign Application Priority Data
Aug. 23, 2003 (KR) 2003-58506

(51) Int. Cl. H01M 2/16; H01M 4/60; H01M 4/40; H01M 4/58

(52) U.S. Cl. 429/137; 429/247; 429/101; 429/213; 429/254; 429/231.95

(57) ABSTRACT

A lithium-sulfur battery includes a cathode, a lithium metal anode, and a separator interposed between the cathode and the anode. The separator contains less than two fluorine atoms per carbon atom to enable a protective layer to form on a surface of the lithium metal anode. The lithium-sulfur battery forms a uniform and dense LiF protective layer on the surface of the lithium metal and stabilizes the lithium metal during its operation. The lithium-sulfur battery prevents the formation of lithium dendrites and inhibits the decomposition of an electrolytic solution to provide improved cycle characteristics and excellent charging/discharging efficiency. In addition, the lithium-sulfur battery blocks the reaction of polysulfide with the surface of lithium metal to prevent a reduction of the lifetime of the battery.

### CLAIM FOR PRIORITY

This application makes reference to, incorporates the same herein, and claims all benefits accruing under 35 U.S.C. §119 from an application for LITHIUM-SULFUR BATTERY earlier filed in the Korean Intellectual Property Office on 23 Aug. 2003 and there duly assigned Serial No. 2003-58506.

### BACKGROUND OF THE INVENTION

1. Field of the Invention

The present invention relates to a lithium-sulfur battery, and more specifically to a lithium-sulfur battery that attains improved charging/discharging efficiency by preventing the formation of lithium dendrites.

2. Description of the Related Art

With the increasing need for smaller portable electronic devices, such as camcorders, portable communication devices, and portable computers, the need for more compact, lighter, thinner batteries having higher capacities to be used as power sources of such portable electronic devices is increasing and considerable research on the batteries is being conducted. Conventional lithium ion secondary batteries utilize a transition metal oxide, such as LiCoO₂ and LiMnO₂, as a cathode active material and carbon as an anode active material. Carbon has a theoretical capacity of 372 mA/g, and the theoretical capacities of LiCoO₂ and LiMnO₂ are 140 mA/g and about 120 mA/g, respectively. Therefore, conventional lithium ion secondary batteries have a lower energy density.

However, when using lithium metal as an anode instead of carbon, a battery has a higher energy density and lower weight since lithium has the lowest density (0.53 g/cm²), and the highest potential difference (−3.045 V vs a standard hydrogen electrode (SHE)) among metals, and a very high theoretical capacity of 3860 mAh/g. On the other hand, when using lithium metal as an anode, a corresponding cathode active material must have a high capacity. Among cathode active materials, sulfur (S₈) has a high capacity of 1675 mAh/g, and is cheap and environmentally friendly compared to transition metal oxides. However, there is still little widespread use of a lithium-sulfur batteries. One of the reasons is that a reaction between polysulfide and lithium metal results in a reduction in the lifetime of the battery. A sulfur molecule becomes isolated from the lithium-sulfur battery and forms a polysulfide, which is soluble in an electrolytic solution and the polysulfide remains as an ion in the electrolytic solution while transferring ions. When using a lithium metal as an anode material, polysulfide anions react with lithium metal and the high theoretical capacity of sulfur cannot be obtained. Furthermore, lithium dendrites grow on the lithium metal anode due to a non-uniform surface reaction during charging and discharging, thereby causing short-circuit and instability of the battery. In addition, when the surface of lithium reacts with the electrolytic solution, the lithium erodes and the electrolytic solution becomes exhausted, thus reducing the length of a cycle.

To overcome these problems, vigorous research has been conducted, and batteries in which additives react with lithium metal in an initial operation to form a lithium alloy, batteries in which a protective layer is chemically formed on a surface of a lithium electrode, and batteries in which a surface of an anode is physically coated with a protective before the production of battery have all been developed.

K. Naoi et al. reported in J. of Electrochem. Soc., 147, 813 (2000) that using the principle that the core of a helical ethylene oxide chain in polyethylene glycol dimethyl ether functions as a path for lithium ions during charging and discharging, a uniform protective layer could be formed for charging and discharging cycles by adsorbing polyethylene glycol dimethyl ether into the surface of a lithium metal. M. Ishikawa et al., disclosed in J. of Electrochem., 473,279 (2000) that growth of lithium dendrites can be suppressed by the formation of lithium alloys by adding aluminum iodide (AlI₃) or magnesium iodide (MgI₂) to an organic electrolyte. However, in these cases, a surface film cannot be maintained in a uniform state after a repetitive charging and discharging cycles and the passage of an immersion time. Also, a satisfactory improvement of charging/discharging efficiency cannot be obtained.

A method of forming a protective layer on the surface of a lithium electrode by adding LiAlCl₄ 3SO₂ to an electrolytic solution and allowing the solution to react with a surface composed of lithium metal is disclosed in U.S. Pat. No. 6,017,651. Also, an anode in which a surface of a lithium electrode is coated with a protective layer containing lithium silicate or lithium borate by sputtering is disclosed in U.S. Pat. No. 6,025,049. However, after many cycles, the protective layer becomes unstable and broken due to intercalation and deintercalation of lithium ions, and thus a considerable amount of electrolytic solution comes in contact with lithium metal via gaps in the protective layer, resulting in the decomposition of the electrolytic solution and a continuing reduction of capacity.

A method of forming a layer of lithium nitride by reacting nitrogen plasma with a surface of lithium has been suggested. However, in this method, the electrolytic solution can penetrate through a grain boundary and lithium nitride is likely to decompose since lithium nitride is unstable in water. Also, it is difficult to use the battery in practical applications due to a low electrochemical stability window of 0.45 V.

The following patents each discloses features in common with the present invention but do not teach or suggest the inventive features specifically recited in the present claims: U.S. Pat. No. 6,025,049 to Ouellette et al., entitle FLUID TRANSPORT WEBS EXHIBITING SURFACE ENERGY GRADIENTS, issued on Feb. 15, 2000; U.S. patent application No. 2004/0142244 to Visco et al., entitled IONICALLY CONDUCTIVE COMPOSITES FOR PROTECTION OF ACTIVE METAL ANODES, issued on Jul. 22, 2004; U.S. patent application No. 2004/0137330 to Lee et al., entitled NEGATIVE ELECTRODE FOR LITHIUM SULFUR BATTERY, METHOD OF PREPARING SAME AND LITHIUM SULFUR BATTERY COMPRISING SAME, issued on Jul. 15, 2004; U.S. patent application No. 2004/0126653 to Visco et at., entitled IONICALLY CONDUCTIVE COMPOSITES FOR PROTECTION OF ACTIVE METAL ANODES, issued on Jul. 1, 2004; U.S. patent application No. 2002/0182508 to Nimon et al., entitled COATED LITHIUM ELECTRODES, issued on Dec. 5, 2002; U.S. patent application No. 2001/0041294 to Chu et al., entitled PLATING METAL NEGATIVE ELECTRODES UNDER PROTECTIVE COATINGS, issued on Nov. 15, 2001; U.S. Pat. No. 6,723,140 to Chu et al., entitled PLATING METAL NEGATIVE ELECTRODES UNDER PROTECTIVE COATINGS, issued on Apr. 20, 2004; U.S. Pat. No. 6,537,701 to Nimon et al., entitled COATED LITHIUM ELECTRODES, issued on Mar. 25, 2003; U.S. Pat. No. 6,402,795 to Chu et al., entitled PLATING METAL NEGATIVE ELECTRODES UNDER PROTECTIVE COATINGS, issued on June 11, 2002; U.S. Pat. No. 6,225,002 to Nimon et al., entitled DIOXOLANE AS A PROCTECTOR FOR LITHIUM ELECTRODES, issued on May 1, 2001; U.S. Pat. No. 6,025,094 to Visco et al., entitled PROTECTIVE COATINGS FOR NEGATIVE ELECTRODES, issued on Feb. 15, 2000; and U.S. Pat. No. 6,017,651 to Nimon et al., entitled METHODS AND REAGENTS FOR ENHANCING THE CYCLING EFFICIENCY OF LITHIUM POLYMER BATTERIES, issued on Jan. 25, 2000.

### SUMMARY OF THE INVENTION

The present invention provides a lithium-sulfur battery that attains an excellent charging/discharging efficiency by continuously forming a uniform and dense passive layer on a surface of the lithium battery.

According to an aspect of the present invention, a lithium-sulfur battery is provided comprising; a cathode containing at least one active material selected from the group consisting of elemental sulfur, solid Li₂Sn (n≧1), a catholyte containing dissolved Li₂Sₙ (n≧1), organo-sulfur and a carbon-sulfur composite polymer having the formula (C₂Sₓ)ₙ (2.5≦x≦50 and n≧2); a lithium metal anode; and a separator interposed between the cathode and the anode and containing less than two fluorine atoms per carbon atom such that a protective layer can form on a surface of the lithium metal anode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a graph of the discharge capacities of lithium-sulfur batteries prepared in Examples 1 to 3 and Comparative Examples 1 to 4;

FIG. 2 is a graph of the cycle efficiency of lithium for coin cells prepared in Preliminary Examples 1 to 3 and Preliminary Comparative Examples 1 to 4;

FIG. 3 are Scanning Electron Microscopy (SEM) photographs of the surfaces of lithium metal electrodes of lithium-sulfur batteries prepared in Examples 1 to 3 and Comparative Examples 1, 3 and 4 after 10 cycles at 1° C.;

FIG. 4 are SEM photographs of the surfaces of lithium metal electrodes of lithium-sulfur batteries prepared in Example 1 and Comparative Example 1 after being left for four weeks;

FIG. 5 is a graph of the cycle efficiency of coin cells prepared in Preliminary Example 1 and Preliminary Comparative Examples 1, 5, 6 and 7;

FIG. 6 is a graph of the alternating impedance for lithium-sulfur batteries prepared in Corresponding Example 1 and Corresponding Comparative Example 1 after 10 cycles at 1° C.; and

FIG. 7 is a graph of the discharge capacity vs. the number of cycles for lithium-sulfur batteries prepared in Example 1 and Comparative Example 1.

### DETAILED DESCRIPTION OF THE INVENTION

In a lithium-sulfur battery using lithium metal, similar to a lithium ion battery, a solid electrolyte interphase (SEI) is formed on a surface of an anode during the first charging/discharging of the battery. Thus, the anode cannot be in direct contact with an electrolytic solution, thereby preventing the decomposition of the electrolytic solution on a surface of the anode. However, lithium can precipitate and attach to or detach from the SEI during the charging/discharging operation. This can make the SEI unstable and even cause the destruction of the SEI. This phenomenon can cause a subsequent decomposition of the electrolyte on the surface of the anode and a continuous reduction of battery capacity. As mentioned above, the reaction between polysulfide and lithium metal and the precipitation of lithium dendrites along the grain boundary of the SEI can cause a rapid reduction of battery capacity depending on the number of cycles, volume changes in the charging/discharging operation, low stability of the battery and so on.

The lithium battery according to an embodiment of the present invention inhibits the reaction of polysulfide with lithium metal and prevents the decomposition of an electrolytic solution and the precipitation of lithium dendrite by forming a uniform SEI containing LiF with a long lifetime on a surface of the lithium metal electrode. The cathode used in the lithium battery according to an embodiment of the present invention contains sulfur as an active material. The active material includes one of elemental sulfur, solid Li₂Sₙ (n≧1), a catholyte containing dissolved Li₂Sₙ (n≧1), organo-sulfur, a carbon-sulfur composite polymer having the formula (C₂Sₓ)ₙ (2.5≦x≦50 and n≧2), and the like.

The lithium battery according to an embodiment of the present invention comprises a cathode containing sulfur, a lithium metal anode, and a separator interposed between the cathode and the anode. The separator contains less than two fluorine atoms per carbon atom and permits the formation of a uniform LiF protective layer on the surface of the lithium metal anode. If the separator contains at least two fluorine atoms per carbon atom, the rheology of the separator can be deteriorated. For example, a large amount of fluoride contained in the separator polymer can react with the lithium metal, thereby destroying a backbone of the separator polymer. The separator can contain 1 to 1.6 fluorine atoms per carbon atom in order to maximize the formation of LiF and attain an optimal rheology in the separator polymer.

Another method of forming an LiF protective layer comprises adding methyl fluoride (CH₃F) to an organic electrolytic solution. However, as charging/discharging is repeated, the LiF layer becomes unstable and a portion of the LiF layer can be destroyed in the manner described above. That is, the LiF layer cannot function as a lasting protective layer. Although an excess of methyl fluoride can form a new LiF layer, it can cause a side reaction resulting in a risk of deterioration of the battery characteristics. Accordingly, there are limits of the methods used for forming a chemical protective layer by adding additives to an electrolytic solution. Since, according to the embodiment of the present invention, a separator containing fluorine is used without adding an additive as a source of fluorine, it is possible to increase the amount of fluorine used without a risk of deteriorating the performance of the battery. Furthermore, a lasting LiF protective layer can be obtained, even though the LiF protective layer deteriorates at first.

The polymer used in the separator according to an embodiment of the present invention includes polyvinylidene fluoride (PVDF), vinylidene fluoride-hexafluoropropylene (PVDF-HFP) copolymer, polychlorotrifluoroethylene, ethylene-tetrafluoroethylene copolymer, ethylene-chlorotrifluoroethylene copolymer, polyvinyl fluoride, vinyl fluoride-hexafluoropropylene copolymer, ethylene-vinyl fluoride copolymer, ethylene-vinylidene fluoride copolymer or a mixture thereof. When using the above-mentioned gelling polymer, at least one plasticizer selected from the group consisting of ethylene carbonate, propylene carbonate, dimethyl carbonate, diethoxy ethane, dibutyl phthalate, dimethoxy ethane, diethyl carbonate, dipropyl carbonate, and vinylidene carbonate can be used to control pores.

Also, the use of an inorganic filler in the separator can increase mechanical rheology and ion conductivity. The inorganic filler can be one of silica, alumina, zirconia, yttrium oxide, clay, zeolite and the like. The amount of the inorganic filler in the separator can be 5 to 40 parts by weight, based on 100 parts by weight of the fluorine-containing polymer. If the amount of the inorganic filler is less than 5 parts by weight, the mechanical rheology and ion conductivity are not increased. If the amount of the inorganic filler is more than 40 parts by weight, the performance of the battery can undesirably deteriorate due to a separation of layers at the interface and so on.

The porosity of the separator is in the range of 20% to 50%. If the porosity is less than 20%, ion conductivity can deteriorate. If the porosity is more than 50%, mechanical strength is weak.

The pore size of the separator is in the range of from 0.1 to 0.7 μm. If the pore size is less than 0.1 μm, the movement of the lithium ions is limited. If the pore size is larger than 0.7 μm, there is a risk that the mechanical rheology of the separator will deteriorate.

The cathode of the lithium battery according to an embodiment of the present invention is prepared by milling one of elemental sulfur, solid Li₂Sₙ (n≧1), a catholyte containing dissolved Li2Sn (n≧1), organo-sulfur, a carbon-sulfur composite polymer having the formula (C₂Sₓ)ₙ (2.5≦x≦50 and n≧2), and the like to obtain particles with an average particle diameter of about 20 μm, adding the obtained particles and a conductor to a binder solution and stirring the resultant product with a ball mill. The resulting product is then mixed with a solvent, such as isopropyl alcohol to obtain a slurry, and the slurry is coated to a uniform thickness using a doctor blade on a substrate of aluminum foil that has been coated with carbon. The coated substrate is then dried in a drying furnace.

The anode of the lithium battery of the present embodiment can be composed of a lithium metal, a lithium metal alloy or a lithium-inert sulfur composite material.

An organic solvent containing lithium salts is used as the electrolytic solution in the lithium battery of the present embodiment. The lithium salts include at least one selected from the group consisting of lithium perchlorate (LiClO₄), lithium tetrafluoroborate (LiBF₄), lithium hexafluorophosphate (LiPF₆), lithium trifluoromethane sulphonate (LiSO₃CF₃), and lithium bistrifluoromethane sulphonyl amide (LiN(CF₃SO₂)₂).

Suitable organic solvents in the present embodiment include benzene, fluorobenzene, toluene, trifluorotoluene (FT), xylene, cyclohexane, tetrahydrofuran (THF), 2-methyl tetrahydrofuran (2-MeTHF), ethanol, isopropyl alcohol (IPA), methyl propionate (MP), ethyl propionate (EP), methyl acetate (MA), ethyl acetate (EA), propyl acetate (PA), dimethyl ester (DME), 1,3-dioxolane, diglyme (DGM), tetraglyme (TGM), γ-butyrolactone (GBL), sulforane, dimethyl sulfone, N-methyl pyrrolidone, tetramethyl urea, crown ether, dimethoxy ethane, hexamethylphosphoramide, pyridine, N,N-diethylacetamide, N,N-diethylformamide, dimethyl sulphoxide, N,N-dimethylacetamide, N,N-dimethylformamide, tributyl phosphate, trimethyl phosphate, tetramethylene diamine, tetramethyl propylene diamine, pentamethyl diethylene triamine, and mixtures thereof.

The lithium battery of the present embodiment is characterized in that the LiF protective layer is formed on the surface of the anode during the operation of the battery. LiF formed this way is contained in an SEI, thereby forming a dense protective layer. This prevents the formation of lithium dendrites and inhibits the reaction of the electrolytic solution with lithium metal or polysulfide with lithium metal.

The present invention will be described in more detail by presenting examples. These examples are for illustrative purpose, and are not intended to limit the scope of the present invention.

### EXAMPLE 1

### 1-1. Preparation of Cathode

A binder solution was prepared in a gel form by dissolving poly(methylmethacrylate) in acetonitrile. Then, Ketjen black was added to the solution as a conductor to ensure electrical conductivity. After dispersing the conductor the conductor in the solution, sulfur (S₈) powder, which had been milled to an average particle diameter of about 20 μm, was added to the solution and stirred for 24 hours using a ball mill. The obtained powder (sulfur:conductor:binder weigh ratio of 70:20:10) was mixed with isopropyl alcohol to obtain a slurry. Then, after milling the slurry for 12 hours with a ball mill, a substrate composed of aluminium was coated with the slurry. Drying was performed with hot air at 60° C. for one hour to obtain a cathode.

### 1-2. Preparation of Anode

A foil of non-oxidized lithium metal having a thickness of 50 μm was used as an anode.

### 1-3. Assembling of Battery

The cathode obtained was placed in a vacuum oven (60° C.) for at lease one day, and then transferred to a glove box with oxygen controlled to perform the subsequent operations therein. A cathode plate and an anode plate were respectively cut to a predetermined size and tabs for the cathode and the anode were respectively attached to the plates. Then, a polyvinylidene fluoride (PVDF) (available from ELF Atochem) separator having a porosity of 30% and a pore size of 0.5 μm was interposed between the cathode and the anode. The product was wound with a constant tension and inserted into a pouch, which was the outer package for the battery. The pouch was sealed with a portion left unsealed for injecting an electrolytic solution.

### 1-4. Injection of Electrolytic Solution

A solution of 1M LiSO₃CF₃ in 1,3-dioxolane/diglyme/sulforane/dimethoxy ethane with a volume ratio of 5:2:1:2 was used as an electrolytic solution. The electrolytic solution was injected into the pouch through the unsealed portion, and then the pouch was completely sealed. Thus, the lithium-sulfur battery was prepared.

### EXAMPLE 2

A lithium-sulfur battery was prepared in the same manner as in Example 1 except that a PVDF-HFP copolymer (available from SAEHAN) having a porosity of 30% and a pore size of 0.25 μm was used as a separator and that a mixture of DME, DGM and DOX with a volume ratio of 4:2:1 was used as an organic solvent.

### EXAMPLE 3

A lithium-sulfur battery was prepared in the same manner as in Example 1 except that a PVDF separator having a porosity of 25% and a pore size of 0.5 μm, and containing, as an inorganic filler, fumed silica (available from Cabot, TS-530) having a surface treated with hydrophobic groups in an amount of 20 parts by weight, based on 100 parts by weight of the polymer of the separator, was used as a separator.

### COMPARATIVE EXAMPLE 1

A lithium-sulfur battery was prepared in the same manner as in Example 1 except that PE/PP/PE was used as a separator.

### COMPARATIVE EXAMPLE 2

A lithium-sulfur battery was prepared in the same manner as in Example 1 except that polytetrafluoroethylene (PTFE: available from Gore tech) was used as a separator and a mixture of DME, DGM and DOX with a volume ratio of 4:2:1 was used as an organic solvent.

### COMPARATIVE EXAMPLE 3

A lithium-sulfur battery was prepared in the same manner as in Example 1 except that PE/PP/PE coated with tetraethylene glycol diacrylate (TTEGDA) was used as a separator.

### COMPARATIVE EXAMPLE 4

A lithium-sulfur battery was prepared in the same manner as in Example 1 except that PE/PP/PE coated with trimethylol propane triacrylate (TMPTA) was used as a separator.

### PRELIMINARY COMPARATIVE EXAMPLE 5

A coin cell (2016) was prepared using lithium metal electrodes as a cathode and an anode, PP/PE/PP as a separator and a mixture of DME, DGM and DOX with a volume ratio of 4:2:1 as an organic solvent, and adding 0.05 part by weight (500 ppm) of aluminium iodide as an additive for forming a lithium alloy, based on 100 parts by weight of the organic solvent.

### PRELIMINARY COMPARATIVE EXAMPLE 6

A coin cell (2016) was prepared in the same manner as in Preliminary Comparative Example 5 except that 0.05 part by weight (500 ppm) of magnesium iodide, based on 100 parts by weight of the electrolytic solution, was added as an additive for forming a lithium alloy.

### PRELIMINARY COMPARATIVE EXAMPLE 7

A coin cell (2016) was prepared in the same manner as in Preliminary Comparative Example 5 except that 0.05 part by weight (500 ppm) of methyl fluoride, based on 100 parts by weight of the electrolytic solution, was added as an additive for forming LiF.

### EXPERIMENTAL EXAMPLE 1

### Test of Discharge Capacity

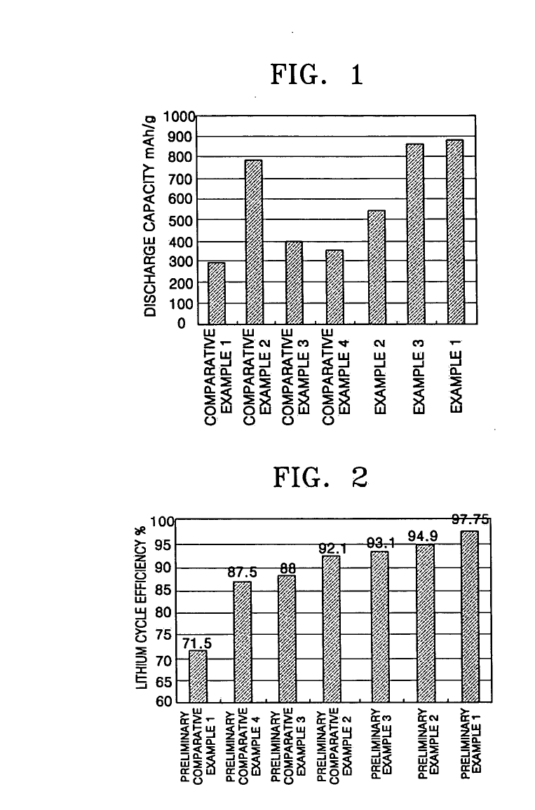

The discharge capacity of each of the lithium-sulfur batteries prepared in Examples 1 to 3 and Comparative Examples 1 to 4 was measured after 10 cycles at 0.5° C. The results are shown in FIG. 1. It can be seen from the results that the lithium-sulfur batteries according to embodiments of the present invention exhibited a higher capacity.

### EXPERIMENTAL EXAMPLE 2

### Test of Lithium Cycle Efficiency

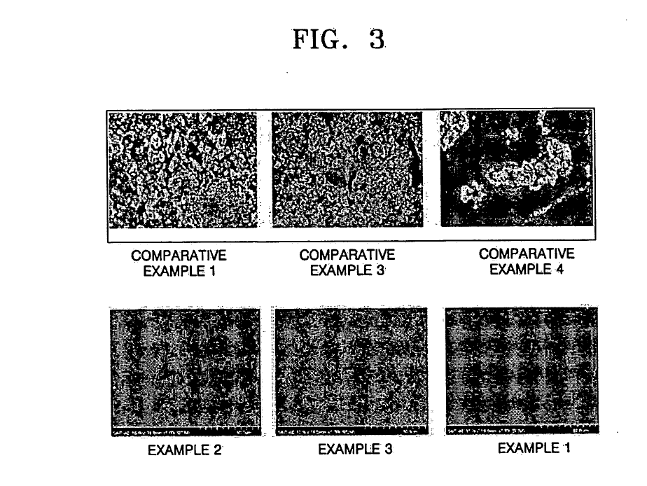

This experimental example was performed in order to confirm whether the larger capacity of the lithium-sulfur battery according to embodiments of the present invention was due to the interaction between the separator and the lithium metal anode included in the battery. Lithium metal electrodes were used as a cathode and an anode, and the same separator, lithium salts and organic solvents as those in Examples 1 to 3 and Comparative Examples 1 to 4, respectively, were used to prepare the corresponding coin cells (2016) (Preliminary Examples 1 to 3 and Preliminary Comparative Examples 1 to 4). Charging/discharging efficiency of each of the coin cells was determined. The results are shown in FIG. 2. The current density was 0.5 mA/cm², and discharge cut-off voltage was 1.5 V. As illustrated in FIG. 2, charging/discharging efficiency of Preliminary Examples 1 to 3 prepared with the separator according to an embodiment of the present invention was higher than that of Preliminary Comparative Examples 1 to 4. This results show that the larger capacity of the lithium-sulfur battery was due to the interaction between the separator and lithium metal anode used embodiments of the present invention.

### EXPERIMENTAL EXAMPLE 3

### Observation of the Surface of Lithium Metal Electrode After 10 Cycles

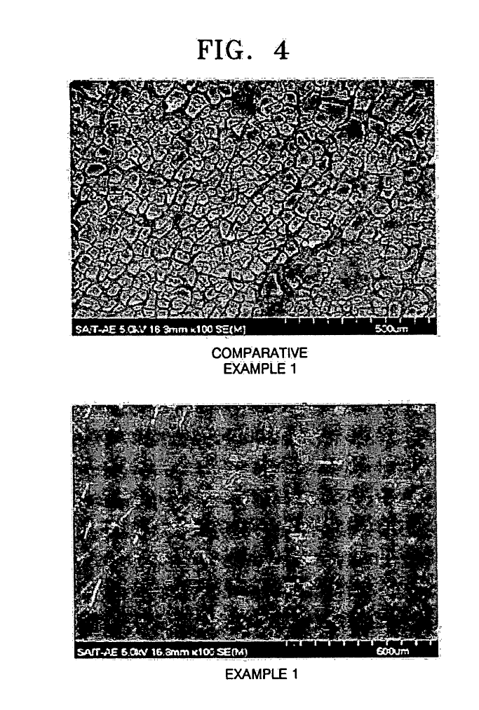

10 cycles were repeated at 1 C for the lithium-sulfur batteries prepared in Examples 1 to 3 and Comparative Examples 1, 3 and 4. Then, the pouch cells were broken and the surfaces of the lithium metal electrodes were washed with THF. Then, in-situ SEM analysis was carried out. The results are shown in FIG. 3. Referring to FIG. 3, the surfaces of lithium metal electrodes in the lithium-sulfur batteries according to embodiments of the present invention were cleaner than those of Comparative Examples 1, 3 and 4. It was confirmed that the presence of the LiF protective layer prevented the formation of lithium dendrites and inhibited the erosion of the lithium surface caused by a reaction with an electrolytic solution.

### EXPERIMENTAL EXAMPLE 4

### Observation of the Surface of Lithium Metal Electrode After Being Left for 4 Weeks

The lithium-sulfur batteries prepared in Example 1 and Comparative Example 1 were placed for 4 weeks. Then, the pouch cells were broken and the surfaces of the lithium metal electrodes were washed with THF. In-situ SEM analysis was carried out. The results are shown in FIG. 4. Referring to FIG. 4, whereas the surface of the lithium metal electrode formed in Comparative Example 1 had many impurities thereon, that of the lithium metal electrode in Example 1 according to an embodiments of the present invention was very clean. The impurities were generated by the erosion caused by the spontaneous reaction of the electrolytic solution with the surface of the lithium metal.

### EXPERIMENTAL EXAMPLE 5

### Test of Cycle Efficiency

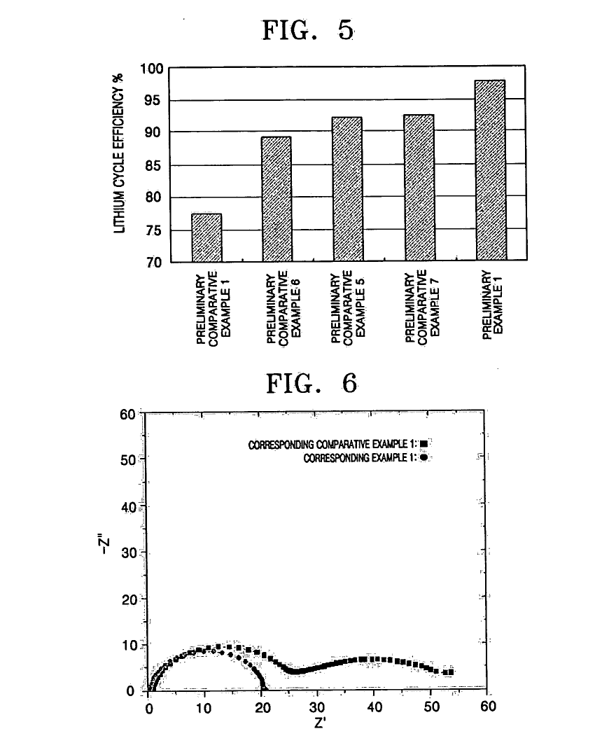

The cycle efficiency was determined for the coin cells prepared in Preliminary Example 1 and Preliminary Comparative Examples 1, 5, 6 and 7. The results are shown in FIG. 5. Referring to FIG. 5, the coin cells having a lithium alloy or LiF protective layer formed by adding the other additives, exhibited better cycle efficiency than the coin cell prepared in Preliminary Comparative Example 1, which used no additives and lower cycle efficiency than the battery according to an embodiment of the present invention. This results from the fact that the protective layer formed by using the additives had less uniformity and consistency than the LiF protective layer according to an embodiment of the present invention.

### EXPERIMENTAL EXAMPLE 6

### Measurement of Alternating Impedance After 10 Cycles

A lithium metal was used for working, counter and reference, and the same separator, lithium salts and organic solvents as in Example 1 and Comparative Example 1, respectively, were used to prepare the corresponding pouch cells (Corresponding Example 1 and Corresponding Comparative Example 1). A cycle charging/discharging test was performed and alternating impedance was measured. The results are shown in FIG. 6. Referring to FIG. 6, Corresponding Comparative Example 1 exhibited at least two arcs and the area below the arcs was at least two times the area under the arc of Corresponding Example 1. The area below the arc corresponds to an interface resistance. A high interface resistance indicates that an SEI formed on a surface of lithium metal is neither uniform nor dense and at least two arcs indicates that at least two SEI were formed on the surface of lithium metal. That is, whereas the results of Corresponding Comparative Example 1 confirmed the formation of at least two SEI (two arc indicate the formation of two SEI), which were neither uniform nor dense, on the surface of lithium metal, the results of Corresponding Example 1 confirmed the formation of a uniform and dense SEI because there was only one arc and the length of the arc was about half compared with the arc of Corresponding Comparative Example 1.

### EXPERIMENTAL EXAMPLE 7

### Test of Discharge Capacity Vs. the Number of Cycles

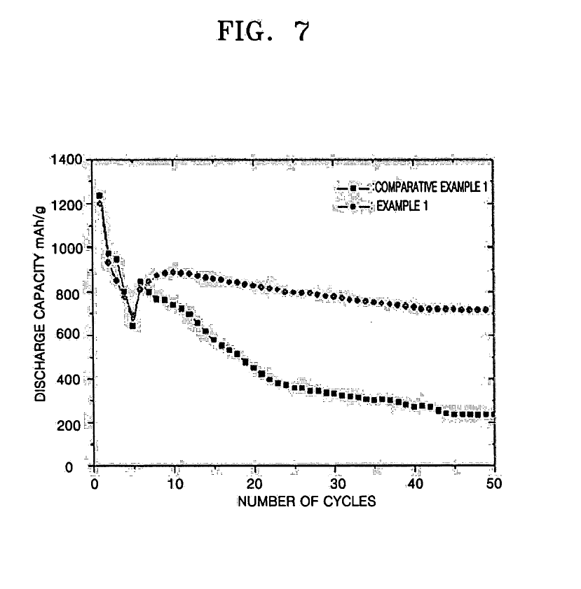

The discharge capacity of each of the lithium-sulfur batteries prepared in Example 1 and Comparative Example 1 was measured during 50 cycles at 0.5° C. The results are shown in FIG. 7. Referring to FIG. 7, the lithium-sulfur battery of Example 1 according to an embodiment of the present invention exhibited better cycle characteristics than that of Comparative Example 1.

As described above, a uniform and dense LiF protective layer can form on the surface of lithium metal and stabilize the lithium metal in a lithium-sulfur battery according to an embodiment of the present invention. Thus, the formation of lithium dendrites can be prohibited and the decomposition of the electrolytic solution can be inhibited in the lithium-sulfur battery, thereby ensuring improved cycle characteristics and excellent charging/discharging efficiency of the battery. In addition, when using sulfur as a cathode material, the lithium-sulfur battery can block the reaction of polysulfide with the surface of lithium metal, thereby preventing a reduction of the lifetime of the battery.

While the present invention has been particularly shown and described with reference to exemplary embodiments thereof, it will be understood by those of ordinary skill in the art that various changes in form and details can be made therein without departing from the spirit and scope of the present invention as defined by the following claims.

1. A lithium-sulfur battery comprising;
a cathode containing at least one active material selected from the group consisting of elemental sulfur, solid Li₂Sₙ (n≧1), a catholyte containing dissolved Li₂Sₙ (n≧1), organo-sulfur and a carbon-sulfur composite polymer having the formula (C₂Sₓ)ₙ (2.5≦x≦50 and n≧2);
a lithium metal anode; and
a separator interposed between the cathode and the anode and containing less than two fluorine atoms per carbon atom to enable a protective layer to form on a surface of the lithium metal anode.

2. The lithium-sulfur battery of claim 1, wherein the separator is composed of a fluorine-containing polymer selected from the group consisting of polyvinylidene fluoride, vinylidene fluoride-hexafluoropropylene copolymer, polychlorotrifluoroethylene, ethylene-tetrafluoroethylene copolymer, ethylene-chlorotrifluoroethylene copolymer, polyvinyl fluoride, vinyl fluoride-hexafluoropropylene copolymer, ethylene-vinyl fluoride copolymer, ethylene-vinylidene fluoride copolymer and a mixture thereof.

3. The lithium-sulfur battery of claim 1, wherein the separator comprises 5 to 40 parts by weight of an inorganic filler, based on 100 parts by weight of the fluorine-containing polymer.

4. The lithium-sulfur battery of claim 1, wherein a porosity of the separator is in the range of 20 to 50%.

5. The lithium-sulfur battery of claim 1, wherein a pore size of the separator is in the range of 0.1 to 0.7 μm.

6. The lithium-sulfur battery of claim 1, wherein the separator contains 1 to 1.6 fluorine atoms per carbon atom.

7. The lithium-sulfur battery of claim 1, wherein the anode is composed of a lithium metal, a lithium metal alloy, or a lithium-inert sulfur composite material.

8. The lithium-sulfur battery of claim 1, wherein the LiF protective layer is formed on the surface of the anode during the operation of the lithium-sulfur battery.
